(19) United States
(12) Patent Application Publication
(10) Pub. No.: US 2004/0203420 A1
(43) Pub. Date: Oct. 14, 2004

(54) Method and apparatus for calculating a representative measurement from multiple data measurements

(76) Inventors: Roland R. Rick, San Diego, CA (US); Jeremy M. Stein, Haifa (IL); Messay Amerga, San Diego, CA (US); Ivan Fernandez-Corbaton, San Diego, CA (US); Borislav Ristic, San Diego, CA (US); Ashok Bhatia, San Diego, CA (US)

Correspondence Address: Qualcomm Incorporated, Patents Department, 5775 Morehouse Drive, San Diego, CA, 92121-1714, US

(21) Appl. No.: 10/120,329

(22) Filed: Apr. 10, 2002

(51) Int. Cl. H04B 17/00

(52) U.S. Cl. 455/67.11; 455/70

(57) ABSTRACT

A method and apparatus for calculating a representative measurement from multiple data measurements of signals from cellular base stations, thereby facilitating utilization of a cellular network to determine position of a mobile station even in non-line of sight and/or dynamic fading environments. A method for calculating a representative measurement includes determining a window of time, selecting data measurements within the window, and calculating a representative time of arrival responsive thereto, such as averaging all data measurements within the window. A representative RMSE estimate may be calculated. To determine a window of time all data measurements within a predetermined window from an earliest time of arrival may be selected. Alternatively the window may be determined by sliding over the data measurements. The data measurements may be stored in a database in a mobile station, and the database is updated to include each new measurement.

### BACKGROUND OF THE INVENTION

1. Field of the Invention

This invention relates to position location systems that utilize wireless signals to determine the location of an electronic device.

2. Description of Related Art

Existing position location technologies based on GPS use a network of satellites in earth orbit that transmit signals at a known time. A GPS receiver on the ground measures the time of arrival of the signals from each satellite in the sky it can “see”. The time of arrival of the signal along with the exact location of the satellites and the exact time the signal was transmitted from each satellite is used to triangulate the position of the GPS receiver. A GPS receiver requires four satellites to make a triangulation and the performance of the resulting position location increases as the number of satellites that can be detected increases.

It has been suggested to use the existing network of cellular base stations In order to locate position, in a similar manner as GPS. Theoretically-speaking, the exact location of each base station, the exact time at which the base station is transmitting, and the time of arrival of the base station's signal at a mobile station (e.g. cell phone) can be used to triangulate the position of the mobile station. This technique is referred to as Advanced Forward Link Trilateration (“AFLT”). A critical problem faced by the mobile station is to measure the time of arrival of the signals it is receiving from each base station. The simplest method of doing this would be to make a single measurement of the time of arrival for each signal. In one example a single measurement consists of correlating the received signal with a locally generated copy of the transmitted signal, and searching for the peak of this correlation. The goal is to measure the time of arrival of the earliest arrival path from the base station.

In practice, it has proven difficult to implement an AFLT system that can accurately determine the position of a mobile station. Measuring the time of arrival, which is critical to the AFLT process, is difficult in a non-line of sight and/or a dynamic fading environment where multiple paths from the same transmitter are fading in and out unpredictably. For example, if the mobile station is behind an obstruction, the signal from the base station may reflect once, or twice, or more along multiple paths before being received by the mobile station. The signal may also go directly through the building, but it may be received as a very weak signal compared to the stronger reflected signal(s).

In part due to the satellites being located in the sky as opposed to on the ground, a GPS system is not intended to operate in dynamic fading and/or non-line of sight environments. Typically, a GPS receiver makes a single measurement of each satellite, or sometimes it may make multiple measurements with dynamic integration lengths to determine the correct integration parameters for centering the dynamic range of the available fixed point processor around the received signal strength. Such an approach is not suitable in an AFLT environment, where multiple paths from the same transmitter are fading in and out unpredictably.

### SUMMARY OF THE INVENTION

A method and apparatus is disclosed herein for calculating a representative measurement from a series of substantially statistically independent measurements of signals from one or more cellular base stations. The method and apparatus can be used to calculate representative measurements from multiple independent measurements of signals from the cellular base stations, thereby facilitating effective utilization of a cellular network to determine position of a mobile station even in non-line of sight and/or dynamic fading environments. The method may be used by itself in an AFLT algorithm; alternatively, in order to enhance performance of a GPS system, the existing network of cellular base stations can be treated as a secondary network of satellites for position location purposes. The AFLT technique, combined with GPS, is referred to as hybrid GPS/AFLT.

A method for calculating a representative measurement from a plurality of substantially independent data measurements from a cellular base station, each of the data measurements including an earliest time of arrival estimate, comprises determining a window of time, selecting data measurements within the window, and calculating a representative time of arrival responsive to the selected data measurements. In some embodiments the step of calculating the representative time of arrival comprises averaging all the time of arrival estimates that fall within the window. The method of determining a window of time may include identifying an earliest data measurement of the time of arrival estimates, and applying a window of time following the earliest data measurement. The window of time may have a predetermined length. Alternative embodiments are described in which the method of determining a window of time includes sliding a window of time over the data measurements, calculating a proposed time of arrival estimate for each window, and selecting one of the windows to provide the representative measurement responsive to the proposed time of arrival estimates.

In some embodiments the plurality of data measurements further include an RMSE estimate for each time of arrival, and in such embodiments the step of calculating a representative measurement comprises calculating a representative RMSE measurement responsive to the RMSE estimates within the window. Furthermore in some embodiments the data measurements further include a time of measurement for each time of arrival estimate and the method for calculating the representative measurement comprises aging the data measurements responsive to the time of measurement.

A method is also disclosed for determining a total energy value for all paths of pilot signal, and providing a representative measurement of the energy of the signal responsive to the total energy value.

In some embodiment the data measurements are stored in a database in a mobile station, and with each new data measurement, the database is updated to include the new measurement. The representative measurements are calculated using the data measurements stored in the updated database.

### BRIEF DESCRIPTION OF THE DRAWINGS

For a more complete understanding of this invention, reference is now made to the following detailed description of the embodiments as illustrated in the accompanying drawing, wherein:

FIG. 1 is a perspective view of a plurality of cellular base stations, GPS satellites, and a user holding a mobile station such as a cell phone;

FIG. 2 is a perspective view of a user holding a mobile station in a multipath environment, illustrating the different path lengths of three paths from the same cellular station;

FIG. 3 is a block diagram of one embodiment of a mobile station incorporating cellular and GPS communication systems, a database that holds data measurements, and AFLT and GPS systems;

FIG. 4. is a flowchart of operations to determine position of a mobile station;

FIG. 5 is a flowchart of operations to obtain a representative measurement from a plurality of data measurements for each pilot signal;

FIG. 6 is a diagram of one embodiment of a PPM database 38 that stores a plurality of data measurements for each pilot signal; and

FIG. 7 is a flow chart of operations in one embodiment to calculate the representative measurements responsive to the data measurements;

FIG. 8 is a flow chart of one database update method for removing data measurements;

FIGS. 9A and 9B show a flow chart of operations in one embodiment to update the database.

### DETAILED DESCRIPTION

Overview

A method and apparatus is disclosed for measuring the time of arrival of the earliest arriving multipath by repeatedly taking data measurements from a group of pilot signals and storing a plurality of statistically independent data measurements for each pilot signal. In one described embodiment, the data measurements are sufficiently spaced out in time that the detected quantities (e.g. energies) of the various received multipaths are substantially statistically independent for each subsequent data-taking cycle. Advantageously, the earliest multipath that might not have been detected during some data measurement cycles due to fading will most likely be detected during other data measurement cycles. In alternative embodiments, measurements are made from two or more different receive antennas, or measurements are made of signals from two or more different transmit antennas or any combination thereof.

After making these repeated measurements and storing them in a database, the problem becomes computing a single representative measurement for the time of arrival of the earliest multipath. One simple method is to choose the earliest of all of the measurements in the database. However, this approach may not be accurate; for example when there is a line of sight path to the base station, all of the measurements in the database consist of measurements of the same received path plus noise. Choosing the earliest gives you a result whose expected value is earlier than the received path, causing an error. A second simple method is to average all of the measurements in the database; however the problem with this is that when there are two or more paths then the average gives a time of arrival between the two or more paths rather than the time of arrival of the earliest path. In order to address the problems caused by multiple paths, one goal of the representative measurement computation is to average enough data measurements to get a substantially unbiased result when the individual measurements are from the same received path. Each individual measurement has an associated estimate of the root mean squared error (RMSE). The general concept is to order all of the individual measurements in time. To avoid including data measurements from another path in calculations, a window of time is defined, and only data measurements within this window are used to calculate the representative measurement. In one embodiment, for every single possible time of arrival, all measurements within a certain window of time are used to compute a metric for that time of arrival. The metric is computed based upon the time of arrivals and the RMSE's. The time of arrival is computed based upon a formula for the window with the minimum metric. In one described embodiment the representative time of arrival for each pilot ID in the database is computed by finding the earliest measurement in the database, and averaging the time of arrival for all measurements within a predetermined window of time from the earliest measurement. In general, regardless of the specifics of the metric and time of arrival computation, the method described herein effectively averages most measurements within a narrow window of the earliest measurements in the database, while excluding measurements more than some threshold away from the earliest measurement in the database. There are many variations of the method of computing the metric for each window and for computing the time of arrival for the window with the minimum metric.

This invention is described in the following description with reference to the Figures, in which like numbers represent the same or similar elements.

Glossary of Terms and Acronyms

The following terms and acronyms are used throughout the detailed description:

AFLT Advanced Forward Link Trilateration

CDMA Code Division Multiple Access

GPS Global Positioning System

GSM Global System for Mobile Communications

Mobile Station A portable device, such as a cell phone, typically carried by a user whose location is to be determined.

Pilot Signal A signal, typically a psuedo-random sequence, emitted by a cellular station for the purpose of establishing communication with remote devices. Although the term “pilot” is often used in the context of CDMA cellular systems, this term also applies broadly to all other cellular communication systems.

RMSE Estimate. Root Mean Squared Error.

TOA. Time of Arrival.

PPM. Pilot Phase Measurement.

Table of Variables

Following is a table that sets forth some of the variables discussed herein:

| Parameter | Description |
|---|---|
| Dₚ | Maximum number of pilot ID's stored in PPM DB |
| Dₘ | Maximum number of measurements stored per PN |
| Nₜ | Maximum number of times a pilot search comes up empty |
| | before setting the RMSE estimates of all the data |
| | measurements to RMSE_{MAX} |
| N_{f} | Parameter used to compute the coefficients of the 1-tap |
| | (N−1)/N types IIR filter employed to estimate Pilot Ec/Io. |
| RMSE_{MAX} | Maximum RMSE that can be stored in the PPM DB. |
| Nₐ | Window length used to select which data measurements |
| | should be used to compute the time of arrival |
| T_{AGE} | Delay before aging RMSE's of measurements |
| T_{MAX} | Maximum time a valid measurement is in the PPM |
| | database. |

Description

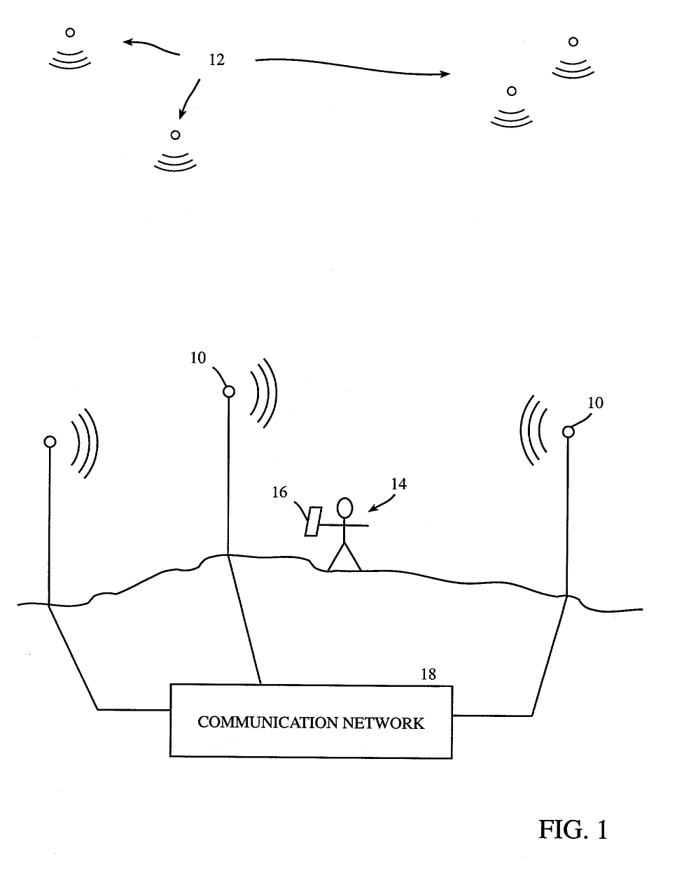

FIG. 1 is a perspective view of a plurality of cellular base stations shown collectively at 10, GPS satellites shown collectively at 12, and a user 14 holding a mobile station 16 such as a cell phone. The cellular base stations comprise any collection of cellular base stations utilized as part of a communication network for connection with the mobile station. The cellular base stations typically provide communication services that allow a user of a cell phone to connect to another phone over a communication network 18; however the cellular base stations could also be utilized with other devices and/or for other communication purposes such as an internet connection with a handheld personal digital assistant (PDA). In one embodiment, the cellular base stations 10 are part of a CDMA communication network; however in other embodiments other types of communication networks, such as GSM networks, may be used. Each of the cellular stations periodically emits a psuedo-random sequence that uniquely identifies the cell station. The psuedo-random sequence is a series of bits that are useful for the receiver to lock upon. In CDMA parlance this psuedo-random sequence is termed a “pilot signal”; as used herein, the term pilot signal can apply to any cellular system as well as to CDMA systems.

The GPS satellites comprise any group of satellites used for positioning a GPS receiver. The satellites periodically send out radio signals that the GPS receiver can detect, and the GPS receiver measures the amount of time it takes for the radio signal to travel from the satellite to the receiver. Since the speed at which the radio signals travel is known, and the satellites are synchronized to periodically emit their signal every millisecond coincident with “GPS time”; therefore it is possible to determine how far the signals have traveled by determining how long it took for them to arrive. To a user situated in open space, the GPS receiver typically has an unobstructed view of the satellites. Thus when the user is in open space, measuring the time of arrival of the GPS signal is straightforward because it is typically a straight “line of sight” from the satellite to the receiver. However, in the cellular context, a user may be situated in a city with buildings or other obstacles that block the direct line of sight and/or reflect the same signal multiple times along multiple paths, and in such an instance the reflected signal(s) may be the only signal(s) detectable.

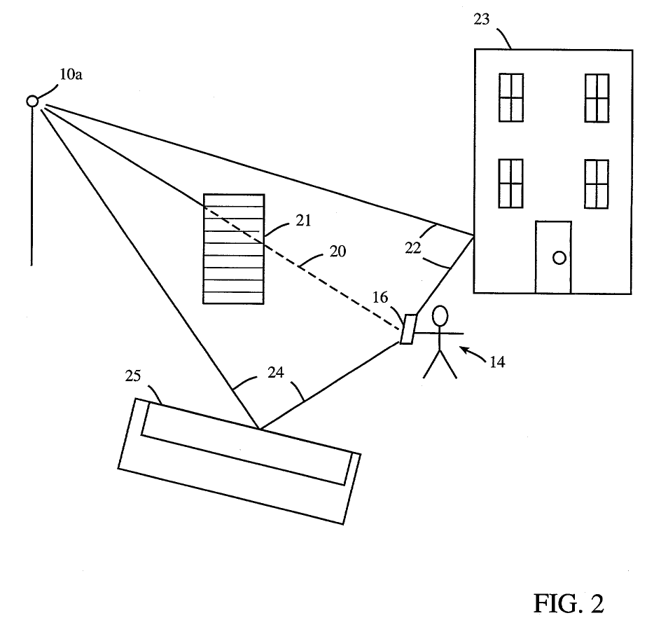

FIG. 2 is a perspective view of a user 14 holding a mobile station 16 such as a cell phone in a multipath environment. FIG. 2 illustrates the multipath problem occurs when the signal from the cellular base station 10a has multiple paths to the mobile station 16. Particularly, a direct signal 20 goes through a first obstruction 21, such as a building, and is attenuated to some extent. A first reflected signal 22 reflects from a second obstacle 23 before being received by the mobile station 16. A second reflected signal 24 reflects from a third obstacle 25 before being received by the mobile station 16. FIG. 2 is simplified for illustration purposes, and it should be clear that other paths may exist, and that in some environments the signal may reflect not just once, but two, three or more times before being received by the mobile station 16. Furthermore, due to attenuation of the direct signal 20 as it passes through the first obstruction 21, one or both of the reflected signals 22 and 24 may be significantly greater in amplitude than the direct signal 20

The amount of time necessary for each signal emitted from the base station 10a to travel to the mobile station 16 depends upon the distance that each signal travels. As each of the signals 20, 22, and 24 are emitted from the cellular base station 10a at the same time, the amount of time difference between the received signals is dependent upon the difference in distance. If amount of the time for the direct signal 20 to travel to the mobile station 16 is tₒ, then the amount of time for the first reflected signal 22 to travel to the mobile station is tₒ+Δt₁, and the amount of time for the second reflected signal 24 to travel to the mobile station is tₒ+Δt₂. The challenge for an AFLT system is to determine the earliest arriving signal, which hopefully corresponds to tₒ, the time of arrival of the direct signal 20.

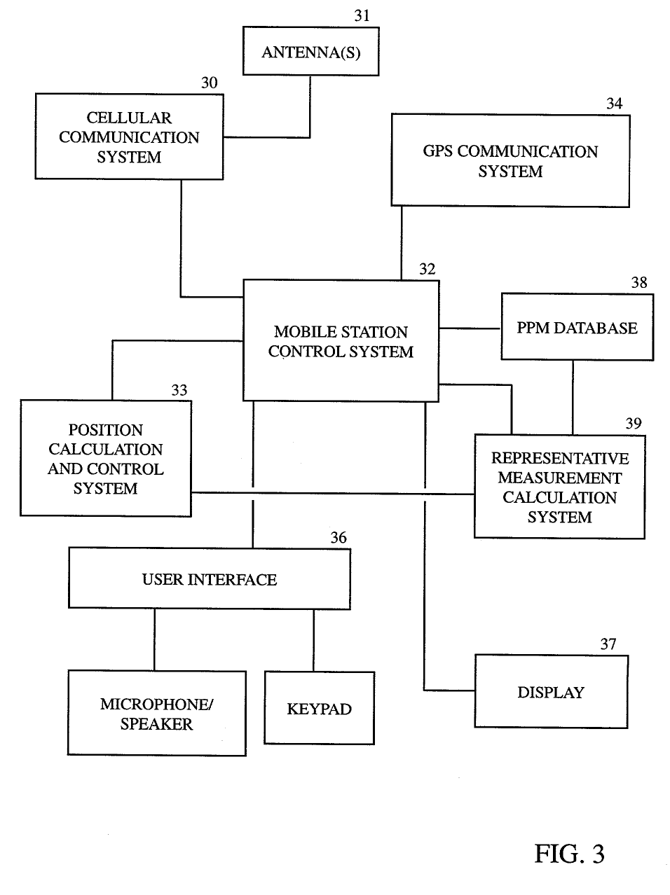

FIG. 3 is a block diagram of one embodiment of a mobile station incorporating cellular and GPS communication systems, and including systems for AFLT as described herein. This embodiment utilizes both GPS and/or AFLT to determine position; however in alternative embodiments AFLT may be used alone. FIG. 3 shows a cellular communication system 30 connected to one or more antennas 31. The cellular communication system comprises suitable devices, hardware, and software for communicating with and/or detecting signals from cellular base stations. The cellular communication system 30 is connected to a mobile station control system 32, which typically includes a microprocessor that provides standard process functions, as well as other calculation and control systems. A position calculation system 33, connected to the mobile station control system 32, requests information and operations as appropriate from the other systems, and performs the calculations necessary to determine position using any suitable AFLT algorithm, GPS algorithm, or a combination of AFLT and GPS algorithms (“hybrid AFLT/GPS”).

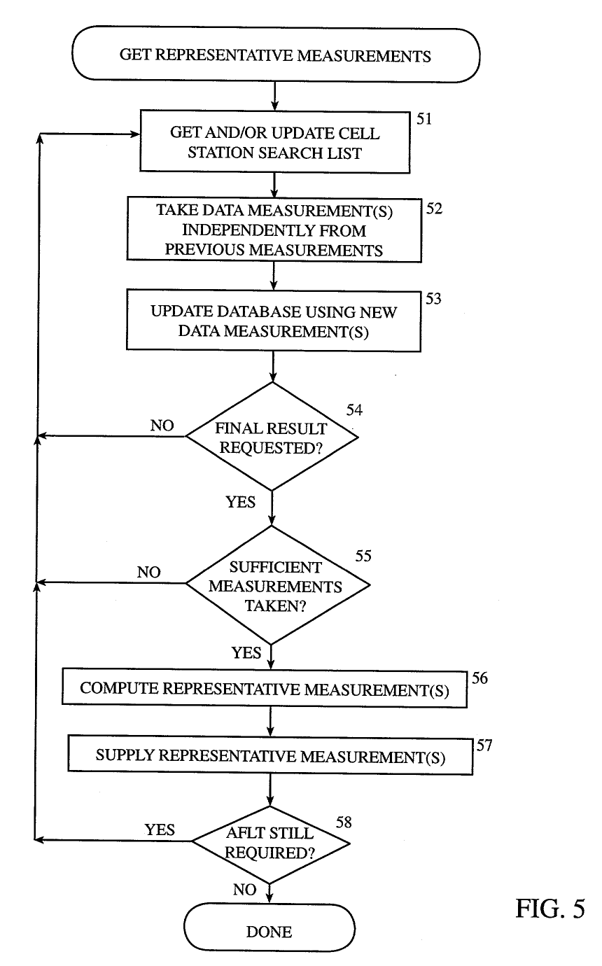

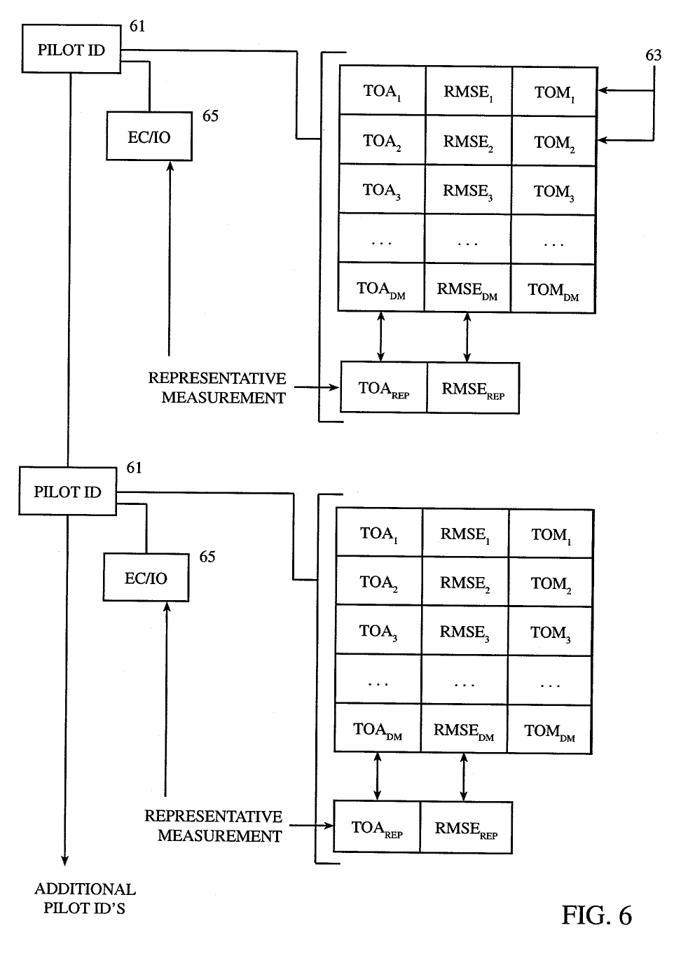

In one embodiment, the cellular communication system 30 comprises a CDMA communication system suitable for communicating with a CDMA network of base stations; however in other embodiments, the cellular communication system may comprise another type of network such as GSM. A GPS communication system 34, which comprises any suitable hardware and software for receiving and processing GPS signals, is also connected to the mobile station control system 32. User input is provided via a user interface 36 that typically includes a keypad. The user interface includes a microphone/speaker combination for voice communication services using the cellular communication system. A display 37 comprises any suitable display, such as a backlit LCD display. A PPM database 38, connected to the control system 32, is provided to store information regarding observed data measurements for a plurality of pilot signals. One example of the database is shown in FIG. 6 and discussed with reference thereto. Each pilot signal is uniquely identified in the database by a pilot ID. A representative measurement calculation system 39 is connected to the control system and the database to calculate the representative measurements for each pilot ID responsive to the plurality of data measurements stored in the database, which is disclosed in detail with reference to FIG. 5. In one embodiment, the representative measurements include an earliest time of arrival estimate, an RMSE estimate for the earliest time of arrival estimate, and an Ec/Io estimate for all resolvable paths of each pilot signal.

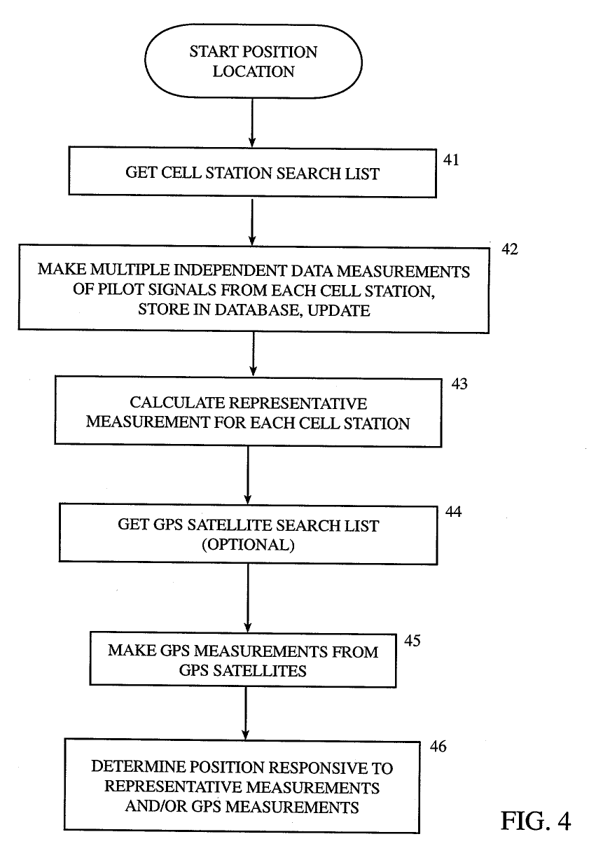

FIG. 4 is a flowchart of operations to determine position of the mobile station using a representative measurement calculation. At 41, a search list of cellular base station neighbors is obtained. The cell search list will be used to search for pilot signals from the cellular stations on the list, and it may also include information useful in finding the pilot signals of the stations on the list.

The cell search list may be obtained in a variety of ways; in one simple embodiment, the cell search list includes all possible pilot signals in a cellular system; however, searching all the possible pilot signals may consume an undesirable amount of time. In order to save time in one embodiment, a local cellular base station communicating with the mobile station can provide the cell search list for the mobile station. Of course, this assumes that the mobile station can establish communication with the local cellular base station (or communication has already been established). Alternatively, such as in the event that communication cannot be established with any cellular base station, the mobile station may simply identify a local cellular base station, and then utilize an almanac stored within itself to determine a cell search list. A cell search list may be inferred from recent activity, or a default search list may be used. For example a cell search list may be inferred from knowledge of the most recent cell station to which the mobile station was connected.

At 42, a plurality of statistically independent data measurements are taken of the pilot signals from each cellular base station on the cell search list. In some embodiments, each data measurement is stored in a database as it is taken and, if necessary or desirable, the database may be updated with each new measurement. It may be noted that, even if the strength of a pilot signal is insufficient to establish communication, the pilot signal may still have enough strength to be detected and to be able to measure the time of arrival and other qualities.

The data measurements are taken in such a manner as to be substantially statistically independent; that is, each data measurement of the same pilot signal is highly likely to be independent from (e.g. substantially not correlated with) all the other data measurements taken of that pilot signal. Statistical independence can be provided by sufficiently separating the data measurements in time, space, frequency or any combination thereof, to provide a high likelihood of independence between data measurements taken of the same pilot signal. The particular technique (or combination of techniques) used to achieve statistical independence varies between embodiments, depending upon objectives such as speed and accuracy, and subject to constraints such as cost, space and energy consumption limitations. Furthermore, it should be recognized that, under any of these techniques channel conditions may occur that would make the measurements correlated to some extent, and accordingly in designing a system that takes independent measurements, assumptions may be made as to which technique (or combination of techniques) will provide substantially independent data measurements most of the time in the expected environment.

One technique to achieve statistical independence is to make a series of data measurements over time, with the time difference between successive measurements at least sufficient to justify the assumption of independence. Typically, the time difference between successive measurements should be chosen such that the fading characteristics of the channel will most likely change from one data measurement to the next. In a non-moving environment, a time difference of at least 20 milliseconds (ms) provides an independent sample, with no maximum time difference except that imposed by practical constraints. Due to practical limitations, the time difference more typically ranges between 100 ms to 2 seconds, and in one embodiment is about 0.5 seconds.

For purposes of implementation, it should be typically assumed that the mobile station is traveling at slow speeds approaching standing still in which theoretically the channel doesn't change; however in practice a fully static channel is usually not achievable. It may be noted that, if the mobile station is in fact moving, the required amount of time spacing will be less due to the difference in location between successive measurements, and accordingly in a moving vehicle the minimum time difference to obtain independence is shorter than for a stationary station.

Another technique to achieve statistical independent is to make independent measurements from two different locations in space. In one such embodiment, data measurements are taken from two or more antennas (see 31 in FIG. 3) where the minimum distance between any two antennas is greater than half the wavelength of the carrier frequency. As a result, the fading characteristics are most likely independent on each received signal. Practical values of antenna separation are generally around half the wavelength of the carrier frequency since usually it is desirable to situate the antennas as close together as possible.

Still another technique to achieve statistical independence is to make data measurements at two or more different frequencies emitted from the same cellular base station. This can be done if the cell stations in the network broadcast the pilot signals on different frequency channels. In this technique, the frequency separation should be at least sufficient to make multiple independent measurements even in fading environment, if the channel conditions are appropriate for this to be the case. Most of the time the frequency channels are spaced by a bandwidth greater than 1 MHz, and in such networks the assumption of independence is usually accurate.

Again, it should be recognized that any combination of the time difference between measurements, taking measurements from different spatial locations, or measuring multiple frequency channels could be used to achieve statistical independence of multiple data measurements.

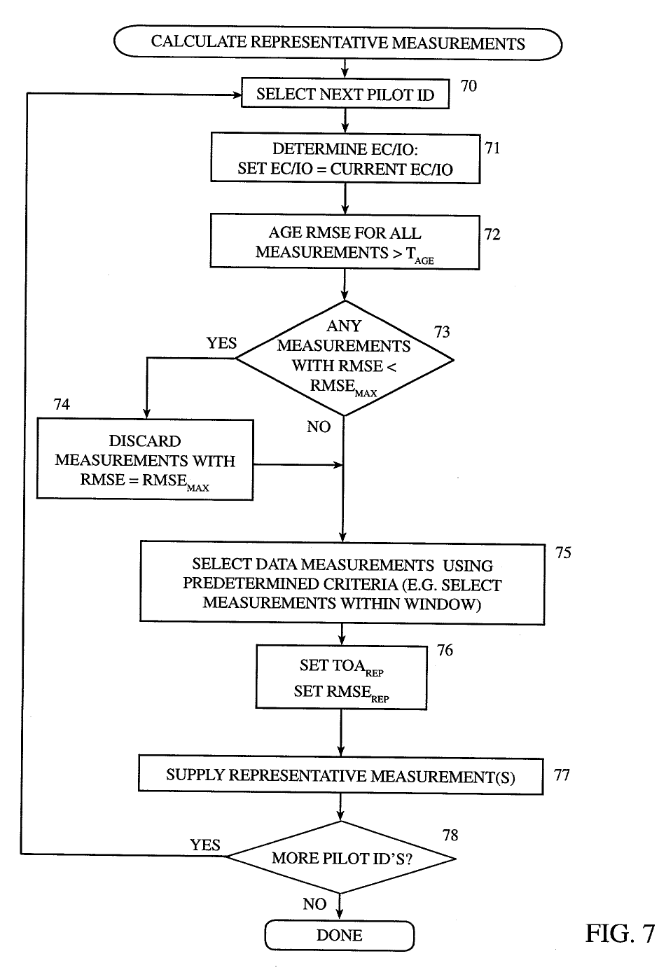

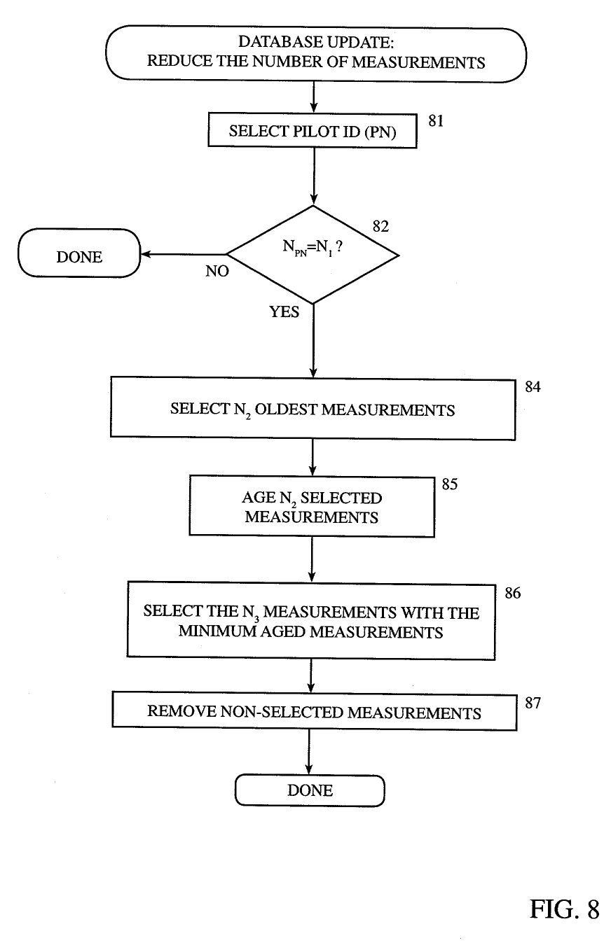

In one embodiment, as will be described, the multiple independent data measurements include an earliest time of arrival (TOA) estimate, an RMSE estimate of the path providing the earliest TOA, and an Ec/Io estimate for all resolvable paths of the pilot signal, which will be used to update the Ec/Io for the pilot signal. The data measurements are typically stored in a database such as shown in FIG. 6 in which each pilot signal is associated with a plurality of related data measurements. In some embodiments, as each new data measurement is received, the database is updated to include the new measurement. Typically, this update process is continually repeated as each new data measurement is received. Particularly, older and/or more unreliable data measurements can be replaced with the most recent data measurements. As part of the update process, such as described with reference to FIG. 8, a determination must be made as to which of the older data measurements are to be kept and/or modified in some way. It may be noted in the embodiment shown in FIG. 6, instead of storing multiple values of the total energy (Ec/Io), only a single value of Ec/Io is stored for each pilot ID. With each new data measurement the stored value of Ec/Io for that pilot ID is updated using a suitable filter such as a 1 tap IIR filter. At 43, the representative measurements are calculated for each cellular base station. Specifically, a single representative measurement is calculated for each cellular base station, responsive to the multiple measurements taken during the search cycle. One representative measurement algorithm is described with reference to FIG. 7. The representative measurements for one embodiment are shown together with the PPM database in FIG. 6.

At 44, a GPS satellite search list is obtained. This is an optional operation, which advantageously provides a search list that can be used by the GPS system to look for satellites and thereby reduce the time necessary to locate sufficient satellites to get a position fix. The GPS search list includes information such as location of each viewable satellite in the sky, and other information that may be useful in locating the satellites and determining the time of arrival of each signal. The GPS search list can be obtained in like manner as the neighbor list at 41, such as by communication with a cellular station or inferred from recent activity in conjunction with an almanac that gives the expected positions in the sky for each GPS satellite. Alternatively, the GPS system can simply search the entire sky; however such a full sky search typically consumes at least several minutes of time.

At 45, GPS measurements are obtained in accordance with suitable GPS procedures. In one embodiment, the GPS communication system first looks for the satellites specified in the viewable satellite list, which can significantly reduce the time required to obtain sufficient GPS signals.

At 46, the position of the mobile station is determined using the representative measurements of the cellular base stations and/or the GPS measurements, as further described in more detail herein, using the position calculation system 33. Using both AFLT and GPS algorithms can be useful: for example if only three GPS measurements can be obtained (four are required for an accurate GPS fix), then a fourth measurement can be obtained from the AFLT representative measurements. Even if four or more GPS measurements can be obtained, the AFLT measurements can act as a check on the accuracy of the GPS fix.

FIG. 5 is a flowchart of operations to obtain representative measurements using the data measurements obtained during previous searches. The following discussion utilizes CDMA terminology and CDMA technology for illustration purposes; however, it should be apparent that other wireless communication systems could also be used. In a CDMA system, each cell base station transmits a unique periodic pilot signal, which is a psuedo-random sequence that allows the receiver to lock upon the pilot and begin communication. Each pilot signal has a distinct sequence offset (sometimes termed “phase”) that distinguishes it from all other cell stations in the vicinity. Furthermore, the cell stations are all synchronized so that each emits its pilot signal at the same time. In a CDMA system the pilot signals are periodically repeated every 26.7 milliseconds.

At 51, the cell search list is obtained (as disclosed above at 41, for example), which saves time by focusing search efforts on those pilot signals that have a reasonable likelihood of being usable.

At 52 independent data measurements are taken of the pilot signals on the search list. Particularly, as each pilot signal is detected, data measurements are made including the earliest time of arrival, and this data is stored in a database. In one embodiment, the data measurements taken for each pilot signal include an earliest time of arrival (TOA) estimate, an RMSE estimate for the path corresponding to the earliest TOA, a measurement time (TOM), and an energy measurement (Ec/Io) for all paths having that pilot signal. It should be noted that box 52 is part of a loop that will be performed multiple times to provide multiple data measurements. At each pass through the box 52, the new data measurements are substantially statistically independent from the data measurements taken in previous passes.

In one embodiment, the data measurements entered into the PPM database for each pilot ID indicate whether the pilot was detected, and if detected, includes a time of arrival, RMSE, time of measurement, and Ec/Io determined as set forth below. Other embodiments may determine these quantities in different ways.

The time of arrival in one embodiment is computed by using the energy of the peak and the energy at +/−0.5 chips away from the peak, and interpolating to determine the value of the peak to the available resolution. The interpolation technique uses a second order polynomial and fits the curve to the three samples of the peak returned by the hardware. The polynomial is given by

y(x)=ax²+bx+c

where x is the value referenced to the center sample returned by hardware. Given this, solutions to a, b and c are:

a=2y(0.5)+2y(−0.5)−4y(0)

b=y(0.5)−y(−0.5)

c=y(0)

The interpolated peak position is in turn given by −b/2a relative to the peak returned by hardware.

The RMSE metric indicates the Ec/Io of the individual path whose phase is being reported. In one embodiment the RMSE estimate is computed using the following linear formula:

$$RMSE = \frac{0.2}{\frac{{E}_{c}}{{I}_{o}}} + 10$$

The desired minimum and maximum reported RMSE values are 10 and 223, respectively. This will allow the mobile station to report Ec/Io values from −4 dB to −30 dB. The result is an RMSE that decays exponentially versus Ec/Io in dB. Using the conditional mean formula to convert the searcher output to Ec/Io, the mobile station in one embodiment can compute the RMSE by using the following formula.

$$RMSE = \frac{{G}^{2} {MN}^{ 2}}{5 \times ( y - {G}^{2} MN )} + 10$$

where y is the raw searcher output, G² is a scaling factor of 9/2048 due to truncation and saturation, N is the number of chips coherently accumulated and M is the number of non-coherent sweeps. In one embodiment the MS truncates the RMSE to an 8 bit unsigned quantity with values ranging from 10 to 223. Under this constraint, the computation in the MS can be given as:

$$RMSE = \{ \begin{matrix}10 & y > 0.4 {G}^{2} {MN}^{ 2} + {G}^{2} MN \\ 223 & y \leq \frac{{G}^{2} {MN}^{ 2}}{1065} + {G}^{2} MN \\ \frac{{G}^{2} {MN}^{ 2}}{5 \times ( y - {G}^{2} MN )} + 10 & otherwise\end{matrix}$$

The Ec/Io metric indicates the total Ec/Io of all of the resolvable paths for a given PN. In one embodiment a resolvable path is defined as any peak above the noise floor for the given search parameters and within a predetermined number (Wₐ) of chips of the strongest peak. The total Ec/Io may be computed using the following formula:

$${( \frac{{E}_{c}}{{I}_{o}} )}_{total} = \frac{{\sum }_{k} {y}_{i} - k {G}^{ 2} MN}{{G}^{2} {MN}^{ 2}}$$

where k is the number of resolvable paths and yᵢ are the searcher outputs for each resolvable path, and G, M, and N are as defined above.

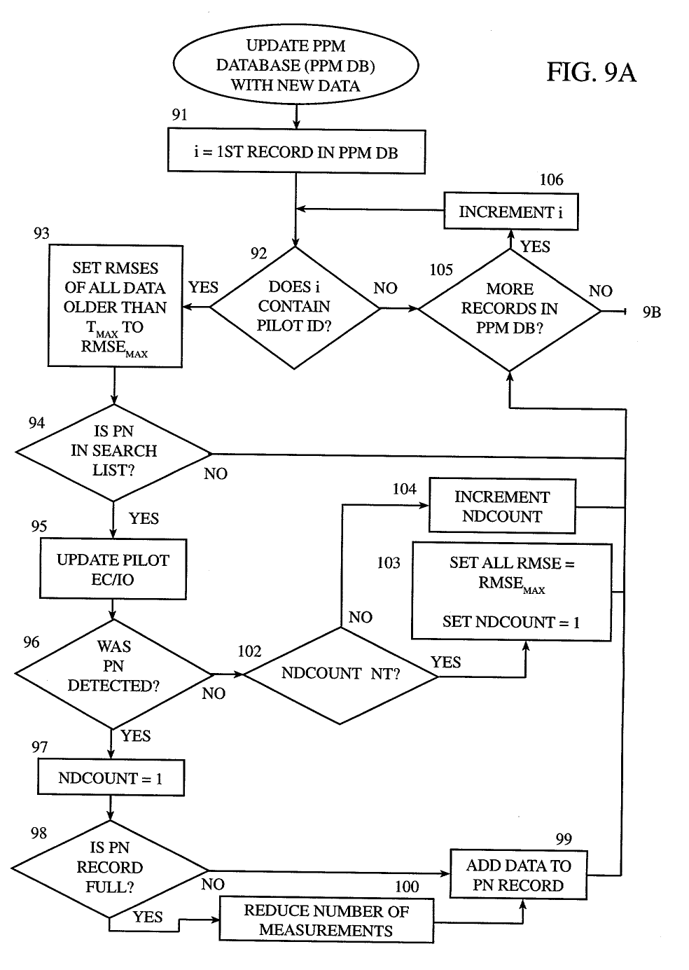

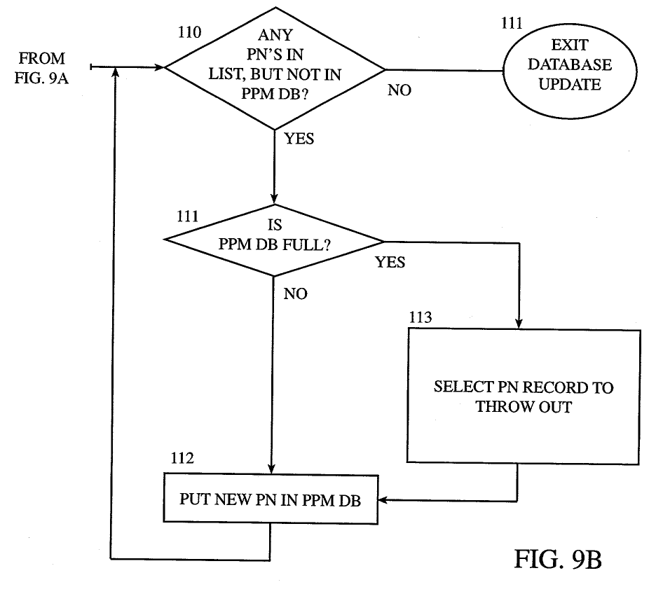

At 53, the most recent data measurements are entered into the PPM database, one embodiment of which is shown in FIG. 6 and discussed with reference thereto. In addition, as described for example with reference to FIGS. 8 and 9, in some embodiments it may be necessary or desirable to update the database as new data measurements are received. Particularly, it is often desirable to replace older and/or more unreliable data measurements with the most recent data measurements. As part of the update process, a determination must be made as to which of the older data measurements are to be kept and/or modified in some way; generally it is desirable to retain as much useful information as possible. In embodiments that have limited memory storage, the database update process can be used as a form of data compression in which data measurements are compressed in such a way as to retain useful information in a smaller memory space.

At 54, in one implementation the mobile station is designed to repeatedly search the pilot signals, take data measurements, and update the database with the new measurements until representative measurements are requested by the mobile station. Of course in other embodiments other strategies may be used; for example one alternative may be simply to repeat the search a fixed number of times (e.g. 20). Until a final result has been requested, the cycle will repeatedly exit box 54 and repeat through the steps 51, 52, and 53 to search the pilot signals, take another measurement and update the database. Once a final result has been requested, then operation will move to box 55.

At decision 55, a determination will be made as to whether or not sufficient data measurements exist in the database to compute a representative measurement. If, at 55, the data is insufficient to calculate a representative measurement, then operation will exit the decision 55 and repeat through the steps 51, 52, 53, and 54 to get another set of data measurements and update the database. Assuming that the mobile station's request for representative measurements at 54 remains outstanding, at the time when sufficient data measurements have been taken, then operation moves on from decision 55 to compute the representative measurements for each pilot signal.

The determination at 55 as to whether or not sufficient data measurements exist can be made in a variety of ways, considering a variety of factors such as the number of measurements that can be stored in the database, the accuracy required, and so forth. In one embodiment, sufficient data measurements exist when a predetermined number (e.g. 10) of data measurement cycles have been completed. In other embodiments other criteria could be used to determine when sufficient data exists, such as after a predetermined length of time (e.g. 6 seconds) has passed. Combinations can also be used to establish the criteria.

At 56, the representative measurements are computed as described for example with reference to FIG. 7. The representative measurements are computed responsive to the multiple measurements stored in the database. In one embodiment the representative measurements provide a single measurement of the time of arrival for each pilot signal, and in addition other information can be included, such as an RMSE estimate.

At 57, the computed representative measurements are supplied to the mobile station for use as desired. For example these representative measurements are useful in an AFLT algorithm for position location, alone or in conjunction with a GPS position location system.

At 58, a determination is made as to whether or not AFLT is still required; i.e. whether additional representative measurements are desired. In some circumstances the system may desire to continually update its position using AFLT, such as in a moving car. If AFLT is required, then the cycle will exit the decision 58 and repeat through the steps 51, 52, and 53, the decisions 54 and 55, and the computation 56, to compute another group of representative measurements. If AFLT is not required, then operation exits from the decision 58 and the representative measurement process is now complete.

FIG. 6 is a diagram of one embodiment of the PPM database 38 (FIG. 3) for storing data measurements made during the process of obtaining a representative measurement such as shown in FIG. 5. In this embodiment, the database 38 is termed a PPM (pilot phase measurement) database. For each pilot signal, an identification number (pilot ID) 61 is given. Each pilot ID is associated with a plurality of stored measurements, shown in FIG. 6 in a plurality of rows 63, each representing a separate data measurement associated with the respective pilot ID. The PPM database supports a finite number of pilot ID's (Dₚ) and a finite number of measurements (Dₘ) for each pilot ID. The actual number of pilot ID's and the actual number of measurements supported for each pilot ID varies between embodiments, and typically depends upon a cost vs. benefit analysis appropriate to the particular implementation and other factors such as the speed of search performed. In one embodiment twenty pilot IDs are supported, and each pilot ID can have up to 5 associated data measurements. The PPM database is implemented in any suitable format including memory, control hardware, and software routines; for example the PPM database may be in the form of a relational database that comprises a plurality of related databases.

For each pilot signal searched, the data measurements in one embodiment includes a Time of Arrival (TOA) estimate and an RMSE estimate for the earliest arriving pilot signal path, and a Time of Measurement (TOM). The TOM is provided so that the respective relevance of each data measurement in a group can be determined and given the appropriate consideration and weight.

In one embodiment the TOA's are stored in digital form, in quantized units of time (e.g. chipxl6, which is approximately 0.05 microsecond). Two bytes (16 bits) may be used for this value. The RMSE estimates are measured in units of U_{RMSE}1 meter. One byte may be used for this value. The TOM values are stored in units of U₅₈ (0.25) sec from the start of running the algorithm. One byte may be used for this value.

In the embodiment shown in FIG. 6, an Ec/Io memory space 65 associated with the pilot ID 61 stores a single value of Ec/Io for each pilot ID. In alternative embodiments, the PPM database may store each data measurement for the total energy (Ec/Io) together with its TOA, RMSE, and TOM. One advantage of the single-value approach is to reduce memory storage requirements, which can be useful in some implementations. Following each new data measurement of Ec/Io, which indicates the total energy of the pilot signal (including all resolvable paths) detected during a search, the stored value of Ec/Io for that pilot ID is updated using a suitable filter. In one embodiment, the stored value for Ec/Io is calculated using a 1 tap HR filter as follows:

$$y [ n ] = \frac{1}{{N}_{f}} x [ n ] + \frac{{N}_{f} - 1}{{N}_{f}} y [ n - 1 ]$$

where N_{f} is a variable chosen to assign the relative weight to the current and previous values of Ec/Io. In one embodiment N_{f}=2, which averages the previous and current values. In summary, in conjunction with each set of data measurements taken in one embodiment, the data measurements taken during that cycle are recorded in the database and the Ec/Io value for each pilot ID is updated using the new information obtained during the search. In the process of recording the data measurements, it may be desirable or necessary to update the database to remove older and/or more unreliable data to make space for the new data measurements. A variety of update processes may be utilized; database update processes are described with reference to FIGS. 8 and 9, for example. Typically, each additional data measurement is stored until the number of data measurements stored exceeds the available space, and then, the database is updated to determine which of the previous measurements will be removed to open a space for the new data measurement. To update the PPM database, a simple rule may be used such as FIFO (first-in, first-out). The update rule varies between embodiments, dependent upon on a variety of constraints and considerations such as the available storage space and the rate at which the data measurements are taken. In such an embodiment, one principle behind the database update is to store the results from previous search cycles and to compress the data measurement in such a way as to limit memory consumption. Furthermore, the database update rule should be chosen so as to not throw away any information except when necessary to make room for newer information, which allows most of the collected intelligence to be used to calculate the representative measurements. As shown in FIG. 6, all the measurements stored in the database are available for use while calculating the representative measurement.

Reference is now made to FIG. 7, which is a flow chart of operations in one embodiment to calculate the representative measurements responsive to the data measurements. The representative measurements can be calculated using a variety of algorithms that implement any of a number of ideas. Some of these ideas are:

1) Every input sample has its own RMSE estimate. In order to appropriately use samples taken at different times, the elapsed period can be taken into account, and the quality metric “aged” according with some increasing function of time.

2) Appearance and disappearances of paths may result in spreads larger than the width of the autocorrelation function. In order to deal with this, only the samples contained in a window of a predetermined size will be selected to be used in calculating the representative measurement.

3) In the context of position location, it is desirable to get as close to a line of sight (LOS) as possible. Therefore, in the process of deciding where to place the window, some preference may be made for earlier TOA measurements.

4) Finally, once all the samples that belong inside the window have been obtained there will be processing to calculate the final result and its RMSE estimate.

One goal of the representative measurement calculation is to report the time of arrival of the earliest detectable path. This can be challenging, and there are many ways in which this can be accomplished. In a stationary environment, it is reasonable to report the earliest peak found for each pilot ID regardless of RMSE, and therefore averaging all measurements within a narrow window of the earliest peak helps reduce bias induced by noise in a stationary environment. However, in a moving environment, it may be desirable to place a greater emphasis on the most recent measurements. For this reason, in the embodiment shown in the flow chart of FIG. 7 the RMSE values are aged by increasing the RMSE values, and the saturated RMSE values (i.e. all RMSE values greater than a threshold) are ignored unless all of the RMSE values for a specific pilot ID are also saturated. The RMSE values are not aged for the first T_{AGE} seconds to prevent unnecessarily saturating weak measurements if they occurred in the previous few search cycles. The RMSE reported is the minimum RMSE of all of the measurements used in computing the average time of arrival so that the representative measurement for the RMSE estimate reflects the Ec/Io of the strongest peak seen at that time of arrival.

In one embodiment the discarded data measurements are not physically removed from the actual PPM database, just ignored for the purpose of calculating the representative measurements. Keeping the discarded measurements in the database allows the database's contents to remain unaffected by how often a representative measurement is requested by the mobile station.

Beginning at the top of the flow chart, the goal is to calculate, for each pilot ID, a single representative measurement of the TOA, RMSE, and Ec/Io that can be used in a position determination algorithm. For convenience these representative values will be referred to as TOA_{REP}, RMSE_{REP}, and Ec/Io_{REP}. Although these representative values are most likely the most important variables for an AFLT algorithm, in alternative embodiments different or additional variables could be utilized.

At 70, the next pilot ID for which representative measurements will be calculated is selected. If this is the first pass through the loop, the first pilot ID will be selected at 70. On subsequent passes through the loop, each subsequent pilot ID is selected until all representative measurements have been determined for all pilot ID's.

At 71, the representative value of Ec/Io is determined. In one embodiment discussed with reference to FIG. 6, Ec/Io is a single value that is repeatedly updated after each search cycle to provide a running average over all instances in which the pilot signal was searched. Thus, in this embodiment the current value of Ec/Io can be used straightforwardly without further calculation, and thus the representative measurement for Ec/Io is set to the current value (Ec/Io_{REP}=current Ec/Io). In alternative embodiments, such as if multiple values of Ec/Io have been stored for a pilot signal, it may be necessary to perform calculations on such stored values of Ec/Io in order to obtain a representative value for Ec/Io. In the PPM database (shown in FIG. 6 for example) for each pilot ID there are multiple data measurements stored corresponding to TOA, RMSE, and TOM. Accordingly, these multiple data measurements must be processed to provide a single value for TOA and RMSE. The representative measurement calculation includes decision-making processes to select which measurements are to be used and which measurements are not to be used to calculate the representative values for TOA and RMSE.

At 72, all measurements for which the TOM is greater than T_{AGE} are aged. One rationale for this is as follows: the uncertainty of a measurement grows as the measurement ages with time in the database. To reflect this growing uncertainty, the RMSE estimates for all the measurements stored in the database are increased dependent upon how old the measurements are. In one embodiment the RMSE estimates older than a predetermined time T_{AGE} are increased linearly. In one embodiment this is accomplished in the following formula:

RMSE_{AGED}=RMSE+max(0,9·(ΔT−T_{AGE}))

where ΔT is the difference between the current time and the time at which the measurement was taken. This formula will not age any RMSE estimates that were taken within the first T_{AGE} seconds; furthermore, older RMSE estimates will be aged linearly.

At 72, the RMSE estimates are aged prior to deciding which measurements to keep in the following steps. In one embodiment to be described, after filtering out and discarding unwanted measurements, the RMSE_{REP} that will be reported will be the minimum of the aged RMSE values.

Generally, “aging” means that less weight will be given to measurements that are further away in time from the last measurement. In one embodiment, the RMSE's are aged linearly. Note that in one embodiment the calculated values for RMSE_{AGE} do not physically replace the RMSE estimate in the pilot phase database; rather the aged RMSE values are used only in the calculation of the representative measurement. This could be useful for example if, during a subsequent calculation of representative values, some of the database values have not changed since the previous representative measurement calculation.

At 73, a decision is made as to whether or not any measurements for the current pilot ID have an RMSE less than the RMSE_{MAX}, which is a predetermined quantity such as 255 in one embodiment. If so, then at 74 the measurements having the maximum RMSE are discarded for purposes of calculation, leaving only those data measurements that have an RMSE less than RMSE_{MAX}. However, if none of the data measurements have an RMSE less than RMSE_{MAX}, then operation continues on using all of the data measurements not yet discarded.

At 75, only data measurements meeting a predetermined criteria are selected for calculation purposes; for example in one embodiment, all data measurements whose TOA is within a predetermined window of time (Nₐ) from the earliest remaining TOA are selected and the remainder are ignored for calculation purposes. For example, if the earliest remaining TOA is 16 microseconds, and the predetermined window Nₐ is 3 microseconds, then all data measurements whose TOA is greater than 19 microseconds are ignored; i.e. all data measurements within the window from 16 microseconds up to and including 19 microseconds are kept. The predetermined window of time may be chosen in light of a variety of factors, such as the number of expected multipaths, the number of data measurements stored, among others.

At 76, the selected measurements are used to calculate the representative values for the pilot ID. In one embodiment the remaining TOAs are averaged to provide TOA_{REP}, and the minimum RMSE value of the remaining RMSE estimates provide the representative value RMSE_{REP}. In embodiments that utilize quantized values to store the TOA, it may be useful if the averaging is performed in such a way that averages exactly in-between two quantized values be rounded to the earlier value (i.e. if the database contains two measurements one unit apart, the average will be equal to the earlier of the two measurements).

Windows can be defined in a variety of ways, and the way the window is defined can affect the representative measurement calculation. Generally, the window selection function selects a subset of measurements within a window of width Nₐ. In some embodiments this window has a predetermined width from the earliest time of arrival. In other embodiments the window can be sliding and/or have a variable width. In a sliding window system, the window is first “placed” by sliding a window of width Nₐ over the TOA measurements for the pilot ID. For each of the window offsets, all windows S with a number of pilots (lₛ) greater than a predetermined number lₛₜₕ (e.g. 2) data measurements are considered. In one implementation, for each window S, a proposed representative TOA estimate dₛ is calculated as follows:

$${d}_{s} = \frac{{\sum }_{s} {y}_{i}}{{l}_{s}}$$

RMSE_{S}=min(σᵢεS)

where □ᵢ is the aged RMSE for the ith measurement. In other words, the RMSE estimate is the minimum of the aged RMSE values for that window S.

Then the representative measurement for each of the pilot ID's is that for the window S for which:

S_{R}=arg_{S} min(d_{S}+β×RMSE_{S})

for some constant β. The representative measurements TOA and RMSE for each pilot ID are d_{S} and rms_{S}.

At 77 the representative measurements, now available, are supplied to the mobile station, including the position calculation and control system.

At the decision 78, if representative measurements are to be calculated for more pilot ID's, then operations continue in a loop through boxes 70 through 78 to calculate the representative measurements for each of the remaining pilot ID's. After all the representative measurements have been calculated, then the representative measurement calculation process is done.

Database Updates

Reference is now made to FIGS. 8, 9A, and 9B which show operations to update the database in some embodiments. In general, the database update process stores the results from each search cycle, and determines which (if any) of the currently stored data measurements should be removed or modified. For example, if the available memory would be exceeded by storing the latest data measurement, the database update may compress, eliminate, or modify one or more of the previously-stored data measurements to make space for the new data.

The database update process can be performed in a variety of ways, such as that shown in FIGS. 8 and 9, dependent upon constraints and design considerations such as cost, available memory, and power consumption. Generally, the database update process should not throw away any information except when necessary to make room for newer information, which allows most of the collected information to be used to calculate the representative measurement. One method for making room for newer information is a first-in, first-out (FIFO) approach, which simply throws out the oldest measurements and stores the new data. However, a strict FIFO approach may not be appropriate if time diversity has a significant impact on performance, and in such situations another method may be used that is biased toward keeping measurements with the earliest time of arrival. Unfortunately, as the session time increases, simply keeping the measurements with the earliest time of arrival could increase the likelihood that falsely detected noise peaks exist in the database.

The database update algorithm can be used to identify and mark possibly incorrect data measurements. For example, failure to detect the peak on subsequent searches is an indication that the peak no longer exists or simply was incorrect data. Thus, if a peak was detected in earlier searches but was not subsequently detected in a predetermined number (N) of consecutive searches, then it may be appropriate to disregard this data. The age (i.e. the amount of time elapsed since the measurement was taken) of a data measurement may also indicate unreliability. To address the problem of old measurements, in one embodiment, the database update process saturates the RMSE (i.e. sets RMSE to RMSE_{MAX}) of all of the measurements older than T_{MAX}, because the maximum value of time the algorithm can store data is T_{MAX} and the saturation prevents a time ambiguity from occurring.

In general, the database may be updated in a variety of ways. Three database update processes are discussed below: 1) reducing the number of measurements for a given Pilot ID, when this reaches the maximum, 2) removing old measurements, and 3) reducing the number of entries to prevent the problem of overflow.

1) Reducing the Number of Measurements

Reference is now made to FIG. 8, which is a flow chart of operations to reduce the number of measurements for a particular Pilot ID (PN) as part of an update process. For each pilot ID reported there will be up to a predetermined number N_{MAX} (e.g. 20) of measurements stored in the database, dependent for example upon the memory allocated to each pilot ID. As shown in FIG. 8, when the number of measurements stored for a particular Pilot ID (N_{PN}) is reached (i.e. N_{MAX}=N_{PN}), the oldest N₂ (e.g. 15) measurements will be compressed to N₃ (e.g. 10) by deleting N₂−N₃ (e.g. 5) measurements. Particularly, at 81 a Pilot ID (PN) is selected. At 82, if the number of data measurements currently stored (N_{PN}) for the Pilot ID is not equal to the maximum number of data measurements allowed, then operation is complete and it is not necessary to reduce the number of measurements for the selected Pilot ID. However if the maximum number has been reached (i.e. N_{MAX}=N_{PN}), then at 84 a predetermined number (N₂) of data measurements, including the oldest measurements are selected.

At 85, the selected N₂ measurements are aged for purposes of determining which are to be removed. In one embodiment a linear aging process is assumed, which simplifies the algorithm because only the best measurements need to be saved. (If this were not the case, some clustering and saving measurements from a number of clusters may be done.) For example, for a typical moving mobile station, the older measurements may be biased with respect to the newer one by at least two aspects: a) assuming that the Epoch counter is not affected by Doppler (the frequency offsets measured by the fingers average to zero-multipaths coming on average from random directions), the old measurements may give shorter measurements (due to moving away from the relevant BTS). and b) due to movement there may be Doppler on the Epoch counter. Thus when comparing old measurements to the new ones, they may have different measured TOA values even though the physical TOA has not changed. Taking into account these two effects, the TOA used for discriminating between the measurements will be increased by some linear function of a nominal speed.

In one embodiment, in order to age the data measurements, an aged time of arrival (TOA_{AGED}) is defined as follows:

TOA_{AGED}=TOA+V·ΔT

where ΔT is the difference between the current time and the time at which the measurement (TOM) was taken, and V is an estimated speed (or preset nominal speed) of the mobile station.

At 86, a predetermined number N₃ (e.g. 10) of the N₂ (e.g. 15) data measurements are selected to be kept by a suitable criteria. For example, the data measurements with the smallest TOA_{AGED} may be selected. In the case of a tie, a suitable tie-breaker may be used, such as selecting the measurement with the smallest RMSE estimate. In one embodiment, the TOA_{AGED} values are used only to decide which data measurements to keep, i.e. the TOA_{AGED} values do not replace the TOA values in the PPM database.

At 87, the non-selected measurements (i.e. the N₂-N₃ measurements) are removed or otherwise eliminated from further consideration. For example the non-selected may be deleted from the database or one of its fields may be set to a value that would ensure that it would be replaced and/or no longer considered.

2) Removing Old Measurements

In some embodiments older measurements may be deleted from the database for one or more of at least three reasons: 1) the limited field for storing time measurements (e.g. 8 bits) may cause ambiguity, 2) in a moving environment, such as when the mobile station is in a moving vehicle, the oldest measurements may no longer accurately represent the current position, and 3) even if more bits for time measurement are available, in a long position session, such as in a moving vehicle that is rapidly changing locations, there may still not be enough bits in the field.

In one embodiment, data measurements are deleted from the database using the following approach for each Pilot ID: if, for at least one data measurement for the Pilot ID, ΔT<T_{MI} (e.g. 30 sec) where ΔT is the difference between the current time and the time at which the measurement (TOM) was taken and T_{MI} is a predetermined value, then delete measurements that have ΔT≧T_{MAX} (e.g. 63.75 sec.).

Furthermore, old measurements may be removed by getting a representative measurement for a Pilot ID, and then setting all current RMSE estimates for that Pilot ID to RMSE_{MAX} (e.g. set to ‘111111’ as defined by IS-801, and also keep a CDMA timestamp for this measurement). In some embodiments, older measurements may be retained for some time; for example it may be useful to use measurements that are not too old to resolve problems of ambiguity. If there is already a representative measurement for this Pilot ID that has not been reported, then the newly-calculated one can replace the previously-calculated one.

3) Preventing Database Overflow Due to New PILOT ID

If a new Pilot ID has just been found, and all the Pilot ID locations in the database are currently occupied, then a place in the database must be vacated to make space for the new Pilot ID. Accordingly, a method must be established to select which of the currently stored Pilot ID's to replace with the new Pilot ID. In one embodiment, a Pilot ID may be selected, and its representative measurements calculated. Particularly, enough places may be vacated by getting representative measurements for a Pilot ID and then inserting the new Pilot ID in its place. In one embodiment, the representative measurement is calculated and the calculated representative RMSE is set to the maximum value of RMSE_{MAX} before clearing the data measurements to make space for the new Pilot ID.

The Pilot ID selected for representative measurements may be chosen using any of various criteria. For example a Pilot ID that has not been detected for the longest amount of time may be chosen; that is, the Pilot ID having the largest minimum ΔT above some minimum threshold may be selected for representative measurement. In another example the Pilot ID with the largest minimum RMSE value may be selected.

FIGS. 9A and 9B (collectively FIG. 9) show a flowchart of operations in one embodiment to update the database. In this embodiment, for each Pilot ID there are three fields that have multiple stored values: the time of arrival (TOA), the RMSE estimate, and the time of measurement (TOM). In addition, there is a single stored value for Ec/Io. In the embodiment shown in FIG. 9, after each search cycle, the contents of the PPM database are updated based on the input provided. The operations performed include: 1) insertion of a new PN detected in the last search cycle and also possibly the removal of an old PN from the database if necessary to make room for the new one, 2) insertion of a new measurement for a PN already in the database and also possibly the removal of old measurements either because they are considered stale or to make room for the new one, and 3) updating the Ec/Io estimate for each PN in the database.

Beginning in FIG. 9A, at 91, a counter i is set to the first record in the PPM database. For purposes of brevity in the flowchart, the PPM database is abbreviated “PPM DB” and Pilot ID is abbreviated “PN”. At 92, the ith record is checked to determine if it contains a Pilot ID. If it does not, then operation moves to 105 to determine if there are more records in the PPM DB, and if so then the counter i is incremented and operation loops back to 92.

If at 92 the currently selected record (the ith record) has a Pilot ID, then operation moves to 93 begin updating that record. At 93, the RMSE estimates of all data measurements for that Pilot ID are aged by setting any data measurements older than a predetermined T_{MAX} to RMSE_{MAX}. Then at 94, the Pilot ID stored is checked to see if it in the search list. If the Pilot ID is not in the search list then operation returns to 105 to continue the loop.

If at 94 the Pilot ID is determined to be in the search list, then at 95 the Pilot ID's Ec/Io value is updated, and operation moves to 96 to determine if a signal was detected for the Pilot ID. If a signal was detected, then at 97 a signal counter NDCOUNT for that Pilot ID is set to “1” and then at 98 a test is made to determine if the ith record is full (i.e. if all data measurement slots are full). If not, then at 99 the new data measurement is added to an empty slot for that Pilot ID, and operation loops back to 105 to determine if there are more records in the PPM database. However, if at 98 the Pilot ID record is full, then at 100 the number of data measurements in that record is reduced (such as discussed with reference to FIG. 8) before adding the new data at 99.

If from 96 the Pilot ID for the ith record was not detected, then a test is made at 102 to determine if the Pilot ID has not been recently detected a predetermined number (NT) of times. Particularly the counter NDCOUNT is checked to determine if it is greater than or equal to NT. If the Pilot ID has not been recently detected (i.e. NDCOUNT>NT, than at 103 the RMSE estimates for all data measurements for that Pilot ID are set to the maximum RMSE_{MAX}, and NDCOUNT is again set to 1. However, if the Pilot ID has been recently detected, then from 102 operation moves to 104 where the counter NDCOUNT is incremented to indicate that the signal has not been detected another time before looping back to 105 to determine if there are any other records.

From 105, where a test is made to determine if there are more records in the PPM database, operation can loop back to increment i and repeat the database update if there are additional records, or if there are no additional records, move to 110 (FIG. 9B) where a test is done to determine if any Pilot ID's are on the search list of found Pilot ID's, but not in the PPM database. If not (i.e. there are no Pilot ID's to be added), then at 111 the database update process is exited. However, if at 110 there are found Pilot ID's that are not in the PPM database, then the found Pilot ID may be added to the PPM database.

At 111, a determination is made to determine if the PPM database is full. If not, then at 112, the found Pilot ID and its data measurement are inserted into the PPM database and operation returns to 110. However, if the PPM database is full, then at 113 an existing record is removed to make space for the new Pilot ID. This may proceed using any appropriate method such as discussed herein with regard to preventing database overflow. In one embodiment the record is removed of the Pilot ID whose newest data measurement is older than the other Pilot ID's. After removal of one (or more) records at 113, then at 112 the new Pilot ID is put into the PPM database and operation loops back to 110 to determine if there are any additional Pilot ID's that should be added to the PPM database. When there are no more Pilot ID's to be added, then the database update process is exited at 111.

It will be appreciated by those skilled in the art, in view of these teachings, that alternative embodiments may be implemented without deviating from the spirit or scope of the invention. This invention is to be limited only by the following claims, which include all such embodiments and modifications when viewed in conjunction with the above specification and accompanying drawings.

What is claimed is:

1. A method for calculating a representative measurement from a plurality of substantially independent data measurements from a cellular base station, each of said data measurements including an earliest time of arrival estimate, comprising:
determining a window of time;
selecting data measurements within said window; and
calculating a representative time of arrival responsive to said selected data measurements.

2. The method of claim 1 wherein said step of calculating said representative time of arrival comprises averaging all the time of arrival estimates that fall within said window.

3. The method of claim 1 wherein said step of determining a window of time includes identifying an earliest data measurement of said time of arrival estimates, and applying a window of time following said earliest data measurement.

4. The method of claim 3 wherein said window of time is predetermined.

5. The method of claim 1 wherein said step of determining a window of time includes sliding a window of time over the data measurements, calculating a proposed time of arrival estimate for each window, and selecting one of said windows to provide said representative measurement responsive to said proposed time of arrival estimates.

6. The method of claim 1 wherein said plurality of data measurements further include an RMSE estimate for each time of arrival, and wherein said step of calculating a representative measurement comprises calculating a representative RMSE measurement responsive to the RMSE estimates within said window.

7. The method of claim 1 wherein said data measurements further include a time of measurement for each time of arrival estimate and said step of calculating the representative measurement comprises aging the data measurements responsive to the time of measurement.

8. The method of claim 1 further comprising determining a total energy value for all paths of pilot signal, and providing a representative measurement of the energy of said signal responsive to said total energy value.

9. The method of claim 1 further comprising utilizing said representative measurement to determine the position of a mobile station.

10. The method of claim 9 further comprising utilizing said representative measurement in an AFLT algorithm to determine position of said mobile station.

11. The method of claim 9 further comprising utilizing said representative measurement together with a GPS algorithm to determine the position of said mobile station.

12. The method of claim 1 further comprising repeating said steps for calculating representative measurements responsive to a plurality of data measurements from a plurality of base stations.

13. The method of claim 1 further comprising obtaining data measurements that are substantially independent in at least one of time, space, and frequency to provide said plurality of substantially independent data measurements.

14. A method for calculating a representative measurement from a plurality of substantially independent data measurements from a cellular base station, each of said data measurements including an earliest time of arrival estimate, comprising:
determining a window of time, including identifying an earliest data measurement of said time of arrival estimates, and applying a predetermined time following said earliest data measurement to provide said window;
selecting all data measurements within said window;
calculating a representative time of arrival responsive to said selected data measurements including averaging the time of arrival estimates that fall within said window.

15. The method of claim 14 wherein said plurality of data measurements further include an RMSE estimate for each time of arrival, and wherein said step of calculating a representative measurement comprises calculating a representative RMSE measurement responsive to the RMSE estimates within said window.

16. The method of claim 14 wherein said data measurements further include a time of measurement for each time of arrival estimate and said step of calculating the representative measurement comprises aging the data measurements responsive to the time of measurement.

17. The method of claim 14 further comprising determining a total energy value for all paths of the pilot signal, and providing a representative measurement of the energy of said signal responsive to said total energy value.

18. The method of claim 14 further comprising utilizing said representative measurement to determine the position of a mobile station.

19. The method of claim 14 further comprising repeating said steps for calculating representative measurements responsive to a plurality of data measurements from a plurality of base stations.

20. The method of claim 14 further comprising obtaining data measurements that are substantially independent in at least one of time, space, and frequency to provide said plurality of substantially independent data measurements.

21. A method for determining the position of a mobile station using a plurality of cellular base stations each emitting a unique pilot signal, comprising:
taking a plurality of substantially independent data measurements of the pilot signals from each of said plurality of cellular base stations, each of said data measurements including an earliest time of arrival estimate for each pilot signal, thereby providing a plurality of independent measurements of the earliest time of arrival for each of the pilot signals from said plurality of cellular base stations;
for each cellular base station, calculating a representative measurement of the earliest time of arrival responsive to said independent measurements for said cellular base station, including
determining a window of time;
selecting data measurements within said window;
calculating a representative time of arrival responsive to said selected data measurements; and
utilizing at least one of said representative measurements to determine the position of said mobile station.

22. The method of claim 21 wherein, for each cellular base station, said step of calculating said representative time of arrival comprises averaging all the time of arrival estimates that fall within said window.

23. The method of claim 21 wherein, for each cellular base station, said step of determining a window of time includes identifying an earliest data measurement of said time of arrival estimates, and applying a predetermined window of time following said earliest data measurement.

24. The method of claim 21 wherein, for each cellular base station, said step of determining a window of time includes sliding a window of time over the data measurements, calculating a proposed time of arrival estimate for each window, and selecting one of said windows to provide said representative measurement responsive to said proposed time of arrival estimates.

25. The method of claim 21 wherein, for each cellular base station, said plurality of data measurements further include an RMSE estimate for each time of arrival, and wherein said step of calculating a representative measurement comprises calculating a representative RMSE measurement responsive to the RMSE estimates within said window.

26. The method of claim 21 wherein, for each cellular base station, said data measurements further include a time of measurement for each time of arrival estimate and said step of calculating the representative measurement comprises aging the data measurements responsive to the time of measurement.

27. The method of claim 21 further comprising, for each cellular base station, determining a total energy value for all paths of the pilot signal, and providing a representative measurement of the energy of said signal responsive to said total energy value.

28. The method of claim 21 further comprising utilizing said representative measurements to determine the position of a mobile station.

29. The method of claim 28 further compri sing utilizing said representative measurements in an AFLT algorithm to determine position of said mobile station.

30. The method of claim 28 further comprising utilizing said representative measurement together with a GPS algorithm to determine position of said mobile station.

31. The method of claim 21 further comprising the step of storing said data measurements in a database in said mobile station, and updating the database following each subsequent measurement.

32. The method of claim 31 wherein said step of updating the database includes aging the RMSE values responsive to a time of arrival for each data measurement.

33. The method of claim 21 wherein said data taking step comprises taking substantially independent measurements in at least one of time, space, and frequency.

34. A system for determining the position of a mobile station using a plurality of cellular base stations each emitting a unique pilot signal, comprising:
data taking means for taking a plurality of substantially independent data measurements of the pilot signals from each of said plurality of cellular base stations, each of said data measurements including an earliest time of arrival estimate for each pilot signal, thereby providing a plurality of independent measurements of the earliest time of arrival for each of the pilot signals from said plurality of cellular base stations;
database updating means for updating the database following taking of each data measurement;
representative measurement calculation means for calculating a representative measurement for each cellular base station, including means for calculating the earliest time of arrival responsive to said independent measurements for each respective cellular base station; and
positioning means, responsive to at least one of said representative measurements, for determining the position of said mobile station.

35. The position determination system of claim 34 wherein:
said data taking means comprises means for taking an RMSE estimate for each time of arrival; and
said calculation means comprises means responsive to said RMSE estimates for calculating a representative measurement for each of said pilot signals.

36. The position determination system of claim 34 wherein:
said data taking means comprises means for taking a time of measurement for each time of arrival; and
said calculation means comprises means responsive to said time of measurement data for calculating a representative measurement for each of said pilot signals.

37. The position determination system of claim 34 further comprising means for aging the data measurements for each pilot signal responsive to the time of measurement data.

38. The position determination system of claim 34 further comprising means for calculating a total energy value for all paths of pilot signal for each cellular station.

39. The position determination system of claim 34 wherein said positioning means includes means for utilizing said representative measurements in an AFLT algorithm.

40. The position determination system of claim 34 wherein said position means includes means for utilizing said representative measurements together with a GPS algorithm.

41. The system of claim 34 wherein said representative measurement calculation means comprises:
means for determining a window of time;
means for selecting data measurements within said window; and
means for calculating a representative time of arrival responsive to said selected data measurements.

42. The system of claim 41 wherein said representative measurement calculation means comprises means for averaging the time of arrival estimates that fall within said window.

43. The system of claim 41 wherein said representative measurement calculation means comprises means for identifying an earliest data measurement of said time of arrival estimates, and means for applying a window of time following said earliest data measurement.

44. The system of claim 41 wherein said means for determining a window of time includes means for sliding a window of time over the data measurements, calculating a proposed time of arrival estimate for each window, and selecting one of said windows to provide said representative measurement responsive to said proposed time of arrival estimates.

45. The system of claim 34 wherein said representative measurement calculation means comprises:
means for determining a window of time, including means for identifying an earliest data measurement of said time of arrival estimates, and applying a predetermined time following said earliest data measurement to provide said window;
means for selecting all data measurements within said window; and
means for calculating a representative time of arrival responsive to said selected data measurements including averaging the time of arrival estimates that fall within said window.

46. The method of claim 34 wherein said data taking means comprises means for taking substantially independent measurements in at least one of time, space, and frequency.
